(19) United States
(12) Patent Application Publication
(10) Pub. No.: US 2025/0054355 A1
(43) Pub. Date: Feb. 13, 2025

(54) Electronic Pull-tab System And Method For Modifiable Paytables

(71) Applicant: Pilot Gaming Systems, Inc., Reno, NV (US)

(72) Inventors: Jon Weaver, Birmingham, MI (US); Anthony M. Morelli, Mt. Pleasant, SC (US)

(21) Appl. No.: 18/764,941

(22) Filed: Jul. 5, 2024

Related U.S. Application Data
(60) Provisional application No. 63/525,647, filed on Jul. 7, 2023.

(51) Int. Cl. G07F 17/32

(52) U.S. Cl. CPC G07F 17/3213; G07F 17/3237; G07F 17/329

(57) ABSTRACT

Systems and methods for providing electronic pull-tab game tickets having paytable modifications are described. The system includes a network component and a gaming device. The network component generates an electronic pull-tab deck including a plurality of electronic pull-tab tickets that each associated with a ticket value, a paytable modification value, a set of final game symbols, and a display area. The gaming device include a processor, a memory, and a display. The network component receives an electronic pull-tab ticket request from the gaming device, then selects one electronic pull-tab ticket having a non-zero paytable modification value. The gaming device receives the electronic pull-tab ticket from the network component and displays the display area corresponding to the electronic pull-tab ticket. An input received at the gaming device triggers the gaming device to display a paytable modification animation corresponding to the non-zero paytable modification value of the received ticket.

### CROSS-REFERENCES

This patent application claims the benefit of provisional patent application 63/525,647 entitled ELECTRONIC PULL-TAB SYSTEM AND METHOD FOR MODIFIABLE PAYTABLES, filed on Jul. 7, 2023; and

the above patent application is hereby incorporated by reference in this patent application.

### FIELD

A system and method for providing electronic pull-tab game sessions are described. More particularly, the electronic pull-tab game sessions include paytable modification animations that are presented prior to revealing the final game symbols.

### BACKGROUND

Typical wagering devices include slot machines and video lottery terminals and are normally managed by various types of computer systems which monitor and control their activities. Such wagering devices are typically located in casinos, racetracks, tribal gaming locations, fraternal organizations, lottery outlets or other authorized locations. These are generally capital-intensive operations requiring a significant capital expenditure.

Wagering system have been developed where a central computer system is interconnected via one or more of a variety of communication mechanisms to a multiplicity of venues where wagering devices, such as VLTs or slot machines, allow players to play via the insertion of cash or equivalent into the machines. The information associated with the wagering devices is transmitted to the central computer, which provides security monitoring and accounting services. Many varieties of such systems exist.

The wagering devices may operate as stand-alone wagering devices, in which the wagering activity and prize awards are handled principally by the retail device, e.g., slot machine, and the central system is tasked with monitoring and reporting activities associated with the retail device. Other stand-alone wagering devices are more highly integrated with the central system, in which the central system performs some or all of the game play and the retail device reflects the wagering results determined by the central system.

Typically, the traditional wagering devices in the retail venues are proprietary devices that incorporate coin and or currency accepting devices. In some instances, the wagering devices may include credit or debit card readers, although that is prohibited by law and/or regulation in many jurisdictions.

More recently, central systems have been developed that use commercial digital tablets or similar mobile devices that are configured and operated at a particular venue. These mobile devices do not have coin or currency readers. Instead, the mobile devices operate in conjunction with a cashier operated point-of-sale (POS) device, or a kiosk. In operation, a cashier will accept funds from a person that desires to use an application on the tablet and the cashier uses functions on the POS device to fund a temporary account that is tied to a particular venue's mobile device; the mobile device is then loaned to the user. In some jurisdictions systems exist that allow personal mobile devices, e.g., smartphones, to be used as a wagering device that operates wagering games in various online configurations.

While these centralized systems provide players greater flexibility as to when and how they play traditional casino and charity games, the fundamental game mechanics the players experience have not changed.

Because there is continuing competition for players' attention from different game animations, volatility, location flexibility, there is a continuing need to provide new interesting gaming opportunities, such as new and interesting gaming mechanics.

### SUMMARY

A method and system for providing electronic pull-tab game tickets having paytable modifications are described. The pull-tab gaming system includes a network component and a gaming device. The network component generates an electronic pull-tab deck including a plurality of electronic pull-tab tickets that are each associated with a ticket value, a paytable modification value, a set of final game symbols, and a display area. The gaming device includes a processor, a memory, and a display. The set of final game symbols includes a plurality of final game symbols, while a plurality of game symbol display positions are associated with the display area. The network component receives an electronic pull-tab ticket request from the gaming device, then selects one electronic pull-tab ticket associated with a non-zero paytable modification value. The gaming device receives the electronic pull-tab ticket from the network component and displays the display area corresponding to the electronic pull-tab ticket. An input received at the gaming device triggers the gaming device to display a paytable modification animation corresponding to the non-zero paytable modification value associated with the received ticket.

The pull-tab gaming method commences when a network component generates an electronic pull-tab deck that includes a plurality of electronic pull-tab tickets. Each of the plurality of electronic pull-tab tickets is associated with a ticket value, a paytable modification value, a set of final game symbols, and a display area. A plurality of game symbol display positions are associated with the display area. The gaming device is communicatively coupled to the network component and includes a processor, a memory, and a display. The gaming device generates an electronic pull-tab ticket request and communicates the request to the network component. In response, the network component selects one electronic pull-tab ticket associated with a non-zero paytable modification value. When the gaming device receives the selected electronic pull-tab ticket associated with the non-zero paytable modification value from the network component, the gaming device displays the display area corresponding to the electronic pull-tab ticket. The gaming device receives an input that causes the gaming device to present a paytable modification animation corresponding to the received electronic pull-tab ticket non-zero paytable modification value.

### BRIEF DESCRIPTION OF THE DRAWINGS

The present invention will be more fully understood by reference to the following drawings which are presented for illustrative, not limiting, purposes.

FIG. 1 shows an illustrative centralized gaming system.

FIG. 2 shows an illustrative authorized mobile device or point-of-sale device.

FIG. 3 shows detail of the mobile wagering sub-system.

FIG. 4 shows an illustrative point-of-sale (POS) device communicatively coupled to authorized mobile devices in a gaming venue.

FIG. 5 shows an illustrative Video Presentation System.

FIG. 6 shows a more detailed view of an illustrative video presentation sub-system (VPS) client.

FIGS. 7A and 7B show an electronic pull-tab ticket gaming method that describes the various steps performed by a player interacting with the gaming system.

FIGS. 8A-D show game screens depicting a first embodiment of the paytable modification animation for an electronic pull-tab ticket game.

FIGS. 9A-D show game screens depicting a second embodiment of the paytable modification animation for an electronic pull-tab ticket game.

FIGS. 10A and 10B show an illustrative flowchart for a method of providing animated paytable modifications for electronic pull-tab tickets.

### DETAILED DESCRIPTION

Persons of ordinary skill in the art will realize that the following description is illustrative and not in any way limiting. Other embodiments of the claimed subject matter will readily suggest themselves to such skilled persons having the benefit of this disclosure. The various illustrative embodiments will now be described more fully with reference to the accompanying drawings. It should be understood that this disclosure and the claims may be embodied in many different forms and should not be construed as limited to the embodiments set forth herein. Additionally, those familiar with computing systems shall appreciate that there are many variants possible for the described systems, depending on the nature of the available networks, legal frameworks, which can open or restrict the types of locations in which the system can be operated, advances in server and networking technologies, etc.

The gaming systems and methods presented herein include a mobile wagering and entertainment system that is designed to be used in wagering applications within legal gaming frameworks. More specifically, the gaming systems and methods presented herein support centralized control of modifiable paytable electronic pull-tab ticket wagering that takes place in multiple wagering venues and provides an integrated broadcast capability so that an entertaining complement to the wagering can be presented on television screens in the gaming venues.

A gaming venue includes a charity, a casino and any other such authorized or licensed gaming venue. Additionally, a gaming venue includes a church, hotel, bar, restaurant, convenience store and other such locations that support licensed gaming activity. Note, that the term “gaming” refers to games of chance or games that include a chance component, in which a wager is received and the awarded prize is dependent on the outcome of the game of chance or of the chance component.

As described in further detail herein, the gaming system and method includes a Mobile Wagering Sub-system (MWS), a Video Presentation Sub-system (VPS), and electronic pull-tab tickets with modifiable paytables. The gaming system is communicatively coupled to a plurality of remote gaming venues, in which each remote gaming venue has at least one mobile client device that supports customer wagering. Additionally, each remote gaming venue may include one or more Point-of-Sale stations that manage player funds. Furthermore, each remote gaming venue may include one or more television monitors that broadcast content complementary to wagering activities. In the illustrative embodiments presented herein, the various elements of the gaming system are communicatively and operatively coupled to one another with a network structure that includes the Internet as the backbone and at least one secure Wi-Fi network within each gaming venue.

The centralized gaming system provides electronic game sessions that include paytable modification animations prior to the reveal of the final game symbols.

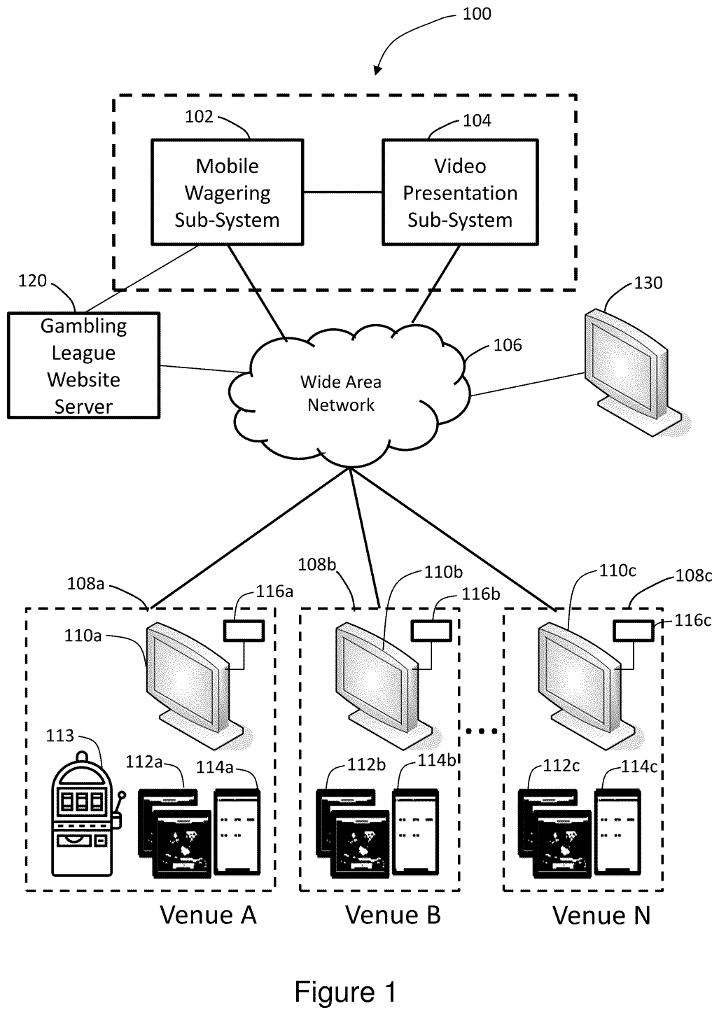

Referring to FIG. 1, there is shown an illustrative centralized gaming system. The centralized gaming system 100 includes a mobile wagering sub-system 102 and a video presentation sub-system 104. The mobile wagering sub-system 102 and the video presentation sub-system 104 are communicatively coupled to one another. Additionally, the mobile wagering sub-system 102 and the video presentation sub-system 104 are communicatively coupled to a Wide Area Network 106, e.g. Internet, which is communicatively coupled to a plurality of gaming venues, namely, gaming illustrative Venue A 108a, Venue B 108b and other such gaming venues as represented by Venue N 108c. Each of the plurality of gaming venues 108a, 108b and 108c include a stationary monitor 110a, 110b and 110c, respectively. Each stationary monitor 110a, 110b and 110c is communicatively coupled to the video presentation client 116a, 116b and 116c, respectively. The video presentation clients 116 are also communicatively coupled to the video presentation subsystem 104. The combination of the stationary monitor 110 and the video presentation client 116 may also be referred as a “stationary monitor client,” and as such reference to “stationary monitor client” refers to the combination of the stationary monitor 110 and the video presentation client 116.

Within the system architecture each gaming venue may be associated with a sponsoring organization, e.g. a charity, and an additional business entity, e.g. a distributor. The types of venues, sponsoring organizations and other business entities will vary according jurisdictional statures and regulation.

Additionally, each of the gaming venues 108a, 108b and 108c include a plurality of authorized mobile devices 112a, 112b and 112c, respectively. Further still, each of the gaming venues includes a Point-of-Sale (POS) device 114a, 114b and 114c. The illustrative authorized mobile devices 112 and the POS devices 114 are client devices configured to communicate with each other and the mobile wagering subsystem 102. In operation, the authorized mobile devices 112 and POS devices 114 are registered with the mobile wagering sub-system 102, which includes a database (not shown) that associates the authorized mobile devices 112 and POS devices 114 with a designated gaming venue 108. Thus, authorized mobile devices 112 and POS devices 114 are not allowed to interact with the centralized gamine system 100 when the client devices are not located at the designated gaming venue.

The illustrative authorized mobile devices 112 operate as wireless client devices that are communicatively coupled to the centralized gaming system 100. Additionally, the centralized gaming system 100 may be communicatively coupled to authorized non-mobile clients. Furthermore, other client devices such as non-mobile clients may be disposed in the gaming venues and these non-mobile clients may be communicatively coupled to the centralized gaming system 100. These authorized non-mobile client devices include, but are not limited to, wired devices such as gaming machines, slot machines, PCs, stationary monitors, Internet appliances, Internet of Things (IoT) devices and other such non-mobile devices with hardwire connections or wireless connections to the Wide Area Network 106. The non-mobile client devices may be configured to participate in the games presented herein including, but not limited to, the tournament games described hereinafter.

Operationally, client devices must comply with the system-centric gaming requirements in which all gaming and accounting activity are controlled by the mobile wagering sub-system 102 servers, and have the communications infrastructure, directly or by proxy, to interact with the server in a manner consistent with the operations of the authorized mobile devices 112 described herein.

The illustrative gaming system 100 includes a plurality of server applications that are configured to provide high-availability and redundancy, process all inputs and generates outputs. The illustrative gaming system 100 includes three different types of network communications. Firstly, there are network communications between the internal server components, namely, the mobile wagering sub-system 102 and the video presentation sub-system 104. Secondly, there are network communications between the server components, e.g. the mobile wagering sub-system 102 and the video presentation sub-system 104, and the remote gaming venues 108a, 108b and 108c, as well as the Gambling League Website server 120. Thirdly, there are network communications within the gaming venues 108a, 108b, and 108c.

With respect to network communications between the internal server components, the illustrative server components operate as a single network, in which the servers can communicate with one another using service requests. By way of example and not of limitation, the illustrative internal server components have two internet protocol addresses, namely, a Private IP used to maintain the server network and ensuring secure server-to-server communication, and a Public IP that is bound to the Internet and that provides access to server services through high security communications such as HTTPS. The internal server components use their private IPs for server-to-server communication so that these services are not exposed to the Internet, the game application running on the authorized mobile devices and the POS devices.

By way of example and not of limitation, each server is configured with an SSL certificate which supports HTTPS calls. The illustrative server is configured to forward some requests it receives through HTTPS to a local port, and the requests that are allowed to pass are only those available to authorized “Game” and “POS” devices. This illustrative configuration ensures that only very specific requests are allowed from the public IP.

By way of example and not of limitation the servers are implemented using the Linux operating system using Restful programming techniques using Java as the programming language with Jersey RS support. Database structures are contained in a MySQL database.

Communication between the server components, namely, the mobile wagering sub-system 102 and the video presentation sub-system 104, and the remote client devices is performed over a wide-area network 106. As described above, these network communications are performed using secure SSL communications over the Internet.

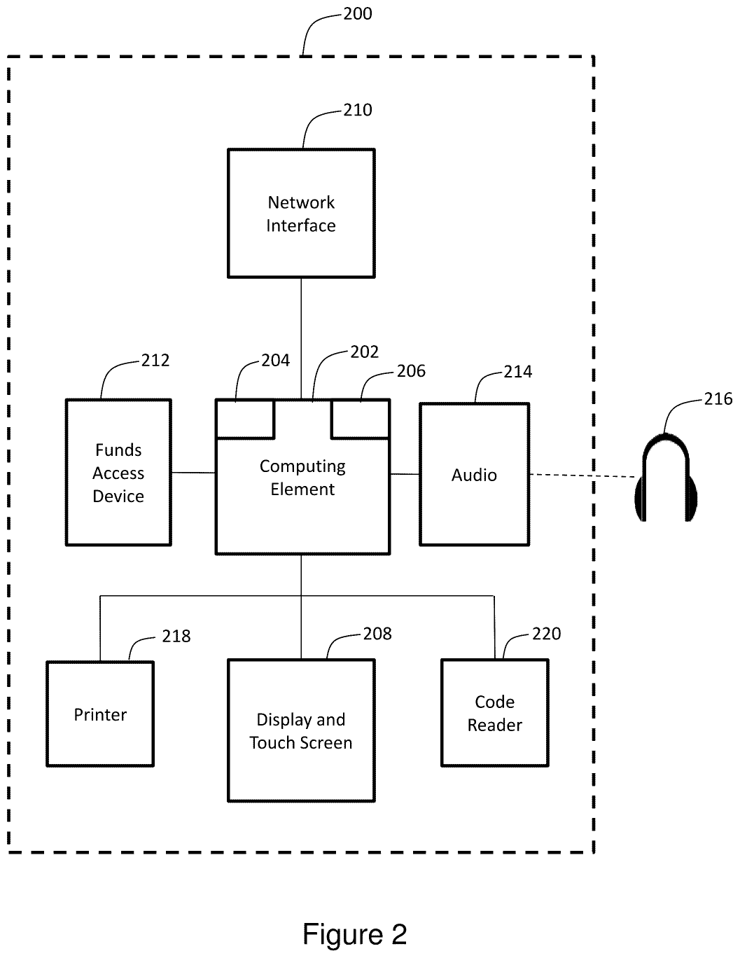

The authorized mobile devices 112a, 112b and 112c are also referred to as a “player interface unit.” An illustrative authorized mobile device is presented in FIG. 2. Operationally, each authorized mobile device 112 in an illustrative embodiment is associated with a player account.

By way of example and not of limitation, the player account is described as a short-term, anonymous entity tied to the client device being used by the player, and which expires when the fund balance drops to zero. However, it is possible in other embodiments to have player accounts which may exist for longer time periods and be tied to a player.

Additionally, it should be noted that while the illustrative embodiments presented herein generally describe financial transactions such as adding funds or cashing out at the POS device 114, in different regulatory environments or with different technology, such player accounts can have financial transactions originating at the player device or any other client device that may be configured to support POS transaction. Also, the financial transactions may be supported at a system level with a server component or server module that provides a web portal functions for financial transactions. Thus, the financial transactions may be performed by the client device, a server component, a server module, or any combination thereof. Depending on regulatory issues and available technology, financial transactions may be based on cash, credit cards, debit cards, digital currency or other mediums of finance.

Referring now to FIG. 2, there is shown an illustrative player interface unit 200. The player interface unit 200 can comprise the authorized mobile device 112, the point-of-sale device 114, and any combination thereof. For example, the illustrative player interface unit 200 may be one of the plurality of authorized mobile devices 112 that is associated with each venue. The illustrative player interface unit 200 includes a central computing element 202 with a processor 204 and memory storage 206. One or more games may be pre-installed on the player interface unit 200 before the player interface units are deployed in a gaming venue or other such production environment. Alternatively, the illustrate game title files may be stored in a remote server, e.g. an “App” store, and the player interface unit 200 may be configured to download the game title file, run the game title file and enable the user to interact with the corresponding game title.

The player interface unit 200 also includes a color display with a touch-screen 208 and a network interface component 210, which provides network access to a local area network, a wide area network or any combination thereof. By way of example and not of limitation the network interface component supports a wireless local area network such as a Wi-Fi network, which is based on IEEE 802.11 standards. Additionally, the player interface unit 200 may communicate with the wide area network 106 via the illustrative Wi-Fi network. The communication between the player interface unit 200 and the mobile wagering sub-system 102 may be performed using the illustrative HTTPS protocol or other such secure networking protocol that allows game session inputs, commands and outputs to be communicated securely across the Wide Area Network.

In an illustrative embodiment, the player interface unit 200 may be a tablet computing device running iOS or Android operating systems. The illustrative player interface unit may also include a Funds Access Device module 212 that may be configured to have a custom locked profile to evade security-bypassing attempts. The Funds Access Devices (FAD) 212 may also provide alternative methods for starting play sessions or adding funds to existing sessions. By way of example and not of limitation, the Funds Access Device module 212 may include currency readers and debit/credit card readers such as a magnetic stripe reader, a smart-card reader, an infra-red reader, a Near-Field-Communications reader and other such financial transaction readers.

The player interface unit 200 may also include an audio system component 214 that enhances the game-playing experience for the players. The audio system component 214 may also include a standard audio jack so that a player can use wired or wireless headphones 216 to improve the game audio environment without disturbing others.

In one illustrative embodiment, the player interface unit 200 may include a printer 218 and a code reader 220. By way of example and not of limitation, the printer 218 generates vouchers. The illustrative code reader 220 may be embodied as a bar-code reader that is configured to read vouchers generated by the printer.

By way of example and not of limitation, the player interface unit 200 may be configured to include a “HELP” button in the game client that also dispatches a signal to the POS to notify the operator that the player is requesting assistance. The player interface unit 200 may also be configured to include a text-to-speech functionality to aid a visually impaired player. Additionally, the player interface unit 200 may include a gaming application that downloads files, decompresses the downloaded files if they have been compressed, and caches all assets inside the player interface unit 200. The player interface unit 200 supports dynamic updates without the need to update the game client itself.

Referring now to FIG. 1 and FIG. 2, the mobile wagering sub-system 102 is communicatively coupled to a plurality of authorized mobile devices 112 such as illustrative player interface unit 200 presented in FIG. 2. In one illustrative embodiment, the mobile wagering sub-system 102 receives a wager input for a game session from the illustrative player interface unit 200. In another illustrative embodiment, the mobile wagering sub-system 102 receives the wager input for a game session from a plurality of authorized mobile devices 112, which may disposed at one or more venues as presented in FIG. 1.

The illustrative player interface unit 200 presents a user interface on touch screen 208 that shows a plurality of game content associated with different types of game sessions. In the illustrative embodiment, the player interface unit 200 may also accept player inputs that are associated with a game session. The game session may perform various operations as described in further detail below.

In the illustrative embodiment, the video presentation sub-system 104 is communicatively coupled to the mobile wagering sub-system 102, the video presentation client 116, and the stationary monitors 110 disposed in the different gaming revenues. The video presentation sub-system 104 generates entertainment output associated with ongoing activity in the mobile gaming system.

One or more of the stationary monitors 110 then receives the entertainment output generated by the video presentation sub-system. The stationary monitors 110a, 110b and 110c then proceed to display the entertainment output generated by the video presentation sub-system 104.

In the illustrative embodiment, a first plurality of authorized devices 112a associated with a first gaming venue 108a includes a first stationary monitor 110a and first video presentation client 116a. Additionally, a second plurality of authorized mobile devices 112b associated with a second gaming venue 108b includes a second stationary monitor 110b and second video presentation client 116b. The first stationary monitor 110a and the second stationary monitor 110 are both communicatively coupled to video presentation sub-system 104. The video presentation sub-system 104 may have stored thereon an entertainment output, such as a video, that is associated with wagering activity. The video presentation sub-system 104 communicates the output, e.g. video, to the first stationary monitor 110a and the second stationary monitor 110b via the video presentation client 116a and 116b, respectively.

By way of example and not of limitation, for an illustrative bingo tournament game that includes a bingo game session, the various stationary monitors 110a, 110b and 110c may present a bingo video related to the bingo tournament game. Thus, a plurality of different authorized mobile devices 112 from different gaming venues 108 can participate in the bingo tournament game and share a similar video experience.

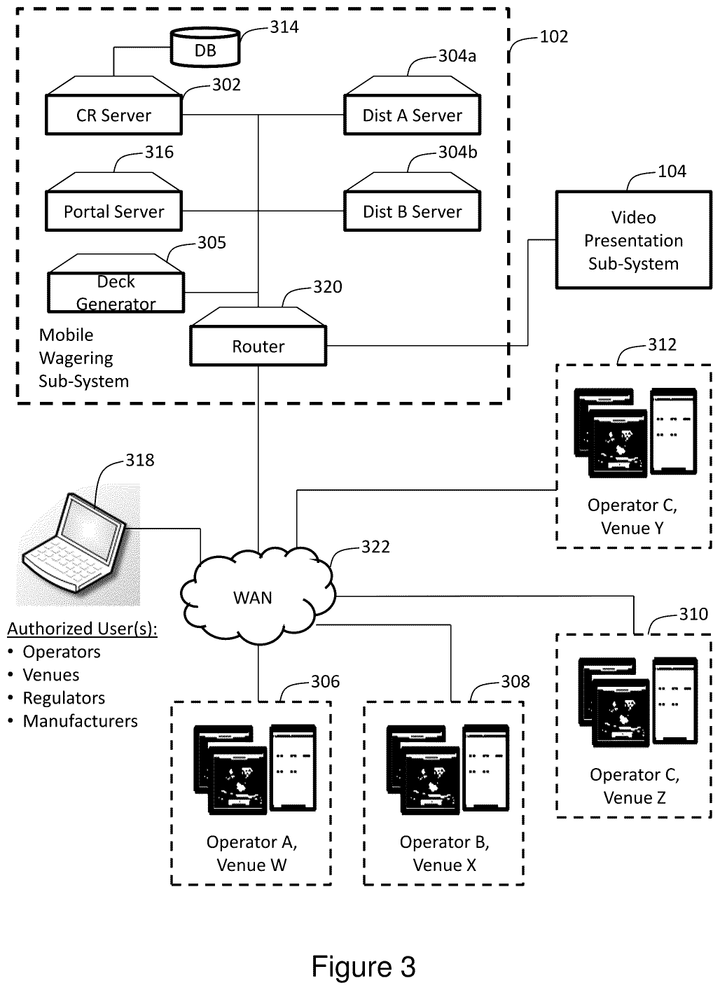

Referring to FIG. 3, there is shown further detail for the mobile wagering sub-system 102 communicatively coupled to different venues. In an illustrative embodiment, the mobile wagering system functionality is distributed on multiple servers, including those that provide database 314 functionality. The illustrative mobile wagering sub-system 102 includes a centralized resource server 302 or centralized manufacturer server that performs as a coordinating entity for system operation and maintains authority over game operations controlled by the centralized gaming system 100. The mobile wagering sub-system 102 also includes a distributor server 304 that is communicatively coupled to the centralized resource server 302.

In the illustrative embodiment presented in FIG. 3, a first distributor server 304a and second distributor server 304b are also communicatively to the centralized resource server 302. Each of the illustrative distributor servers is configured to manage and control the game operations and cashier operations performed at a set of gaming venues that are associated with a distributor who is responsible for sales and support of a multiplicity of venues.

For example, a first set of gaming venues 306 and 308 are configured to communicate with first distributor server 304a, which manages and controls the game operations at gaming venues 306 and 308. Additionally, for a second set of gaming venues 310 and 312 are configured to communicate with the illustrative second distributor server 304b manages and controls the game operations at gaming venues 310 and 312. Thus, multiple gaming venues may require additional distributor servers.

A variety of tasks may be performed by the centralized resource server 302. For example, one of the tasks performed by the centralized resource server 302 includes providing a central routing operation for each of the authorized mobile devices 112 so that each authorized mobile device 112 is routed to the proper distributor server 304a or 304b upon activation of each authorized mobile device. By way of example and not of limitation, the first request generated by a player interface unit 200 may direct the player interface unit 200 to an illustrative distributor of the player interface unit 200.

Additionally, the centralized resource server 302 may be configured to provide a central routing operation for cashier authentication. Thus, a cashier device may be authenticated by the appropriate distributor server 304, which may then forward an authentication to an illustrative mobile device distributor.

The centralized resource server 302 may also be configured to operate as a central authority for generation of finite decks of predetermined electronic pull-tab results, including modifiable paytable electronic pull-tab decks and their associated results. In some embodiments, the mobile wagering sub-system 102 further includes a separate deck generator server 305 that operates as the central authority for generation of finite pool decks of predetermined electronic pull-tab results, including the modifiable paytable electronic pull-tab decks and their associated results. In these embodiments, the deck generator server 305 is communicatively coupled to one or more of the distributor servers 304a and 304b, as well as to the centralized resource server 302, and the deck generator server 305 both randomizes the decks of electronic pull-tabs and distributes the randomized tickets from the decks.

In another illustrative embodiment, a separate system (not shown) may be responsible for generation of one or more finite decks, in which a distributor server (not shown) or centralized resource server (not shown) may communicate with a deck generator server (not shown) to randomize finite pool decks.

Furthermore, the centralized resource server 302 may be configured to manage and control financial information. The centralized resource server 302 may include a centralized database 314 that stores data generated by the cashiers, authorized mobile devices, and the various gaming venues. The centralized database 314 provides a central repository for accounting data, game play data, system configuration data, and other such data types.

The illustrative distributor servers 304 are communicatively coupled to the centralized resource server 302. Each of the distributor servers 304 may be configured to manage finances for the player accounts that are associated with the authorized mobile devices. Additionally, the illustrative distributor servers 304 may be responsible for generating logs and reports required for the POS devices. Furthermore, the illustrative distributor servers 304 may be configured to manage game play operations, wagers and prizes. Further still, the illustrative distributor servers 304 may manage cashier operations including customer sales and redemptions. Further yet, the distributor servers 304 may be configured to maintain the financial status for the authorized mobile devices, including the actual credit balance on each player device.

In an alternative embodiment, the operations performed by the centralized resource server 302 and the distributor server 304 may be performed by a centralized resource software module (not shown) and a distributor software module (not shown) that may be associated with a client-server architecture, a distributed architecture, a peer-to-peer architecture, a hierarchical architecture, a “cloud” architecture or any combination thereof.

The mobile wagering sub-system 102 may also include an illustrative web portal server 316. The web portal server 316 provides a web interface to access system accounting and operational data, as well as to maintain and configure the system. The web portal server 316 is configured to support creating, editing and removing entities like distributors, operators, venues, cashiers, devices, game parameters and others as required. All actions performed on the portal are logged for auditing purposes. This action log can be access on the portal itself if the user has the necessary system privilege.

Additionally, the pull-tab gaming system and method described may be embodied in a fixed slot machine style cabinet communicatively coupled to one or more servers, such as a Casino Management System (CMS), which is well known in the art. The illustrative CMS server would operate as a network component.

By way of example and not of limitation, the web portal server may be accessed from personal computers or tablet devices 318 over the internet. Authorized users having “administrator” privileges may access system reports and controls based upon their operational needs and organizational affiliation. The web portal server 316 supports a variety of different authorized users having different roles with different levels of access to the mobile wagering sub-system 102. For example, the web portal server may be configured to support the following roles: regulator, manufacturer, distributor with access to multiple operators, operator with access to multiple venues, a particular venue, a particular cashier and other such preconfigured roles.

An illustrative router 320 is disposed within the mobile wagering sub-system 102. The router 320 is communicatively coupled to a wide area network 322, e.g. Internet, which is communicatively coupled to the various venues and authorized users. Additionally, the illustrative router 320 is communicatively coupled to the portal server 316, the video presentation sub-system 104, each distributor server 304 and the centralized resource server 302. The router 320 forwards data packets to the appropriate server, network, internet appliance, sub-system and other such destination. Additionally, the router 320 may include a firewall that supports secure communications with the mobile wagering sub-system.

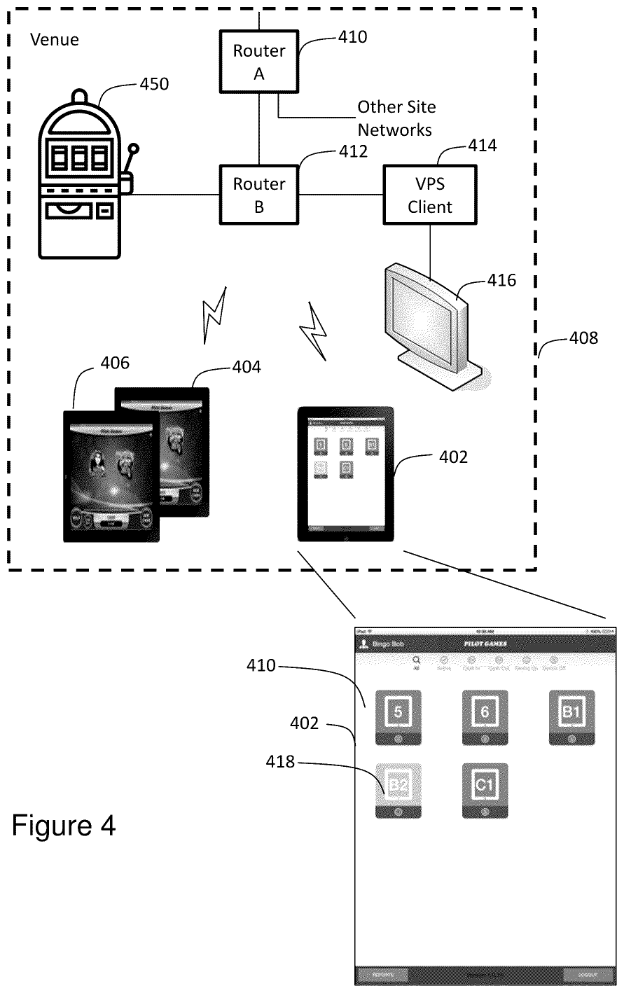

Referring now to FIG. 4, there is shown an illustrative point-of-sale (POS) device communicatively coupled to authorized mobile devices in a gaming venue. The illustrative POS device 402 is communicatively coupled to one or more authorized mobile devices 404 and 406 in gaming venue 408. By way of example and not of limitation, the illustrative POS device 402 is communicatively coupled to authorized mobile devices with a native Socket implementation inside a Local Area Network. An exploded view of an illustrative user interface 410 corresponding to POS device 402 is also shown.

The point-of-sale device 402 is configured to manage all cash operations such as cash-in operations and cash-out operations. The cash-in and cash-out operations may be requested by the authorized mobile device 404, the authorized mobile device 406, the POS 402 or any combination thereof.

The illustrative point-of-sale (POS) device 402 and authorized mobile devices 404 and 406 may be embodied as a mobile device as described above in FIG. 2. The illustrative POS device 402 is a client device configured to receive and operate an illustrative proprietary POS Application. The authorized mobile devices 404 and 406 are client devices configured to receive and operate a proprietary Game Application. The illustrative POS device 402 and authorized mobile devices 404 and 406 are communicatively coupled with the mobile wagering sub-system 102. In the illustrative embodiment, the client devices communicate with the mobile wagering sub-system 102 for each transaction. More generally, all wagering and accounting information is monitored and stored in the centralized gaming system 100 and the client devices always reflect the information received from the centralized gaming system 100. For reasons of security and consistency all game play decisions and financial data is hosted in the centralized gaming system and only visually reflected in the client devices.

As shown in FIG. 4, the illustrative wide area network 106, e.g. Internet, (shown in FIG. 1) is communicatively coupled to the illustrative gaming venue 408. In the illustrative embodiment, the illustrative wide area network terminates at Router A 410. The illustrative Router A 410 may be a pre-existing router located at the venue 408 and usable for multiple purposes, depending on the needs of the venue. For example, Router A 410 may be a component of a cable IV system. In the illustrative embodiment, a second Router B 412 is also communicatively coupled to router A 410. Illustrative Router B 412 is configured to support the requirements for communications with the mobile wagering sub-system 102 and video presentation sub-system 104.

In the illustrative embodiment, router B 412 establishes two private Wi-Fi SSIDs to be used only at a specific site. Each Wi-Fi SSID includes a security key that is unique to that site and is not available to site personnel. One SSID may be used for the exclusive use of the mobile wagering sub-system 102 and a second SSID may be provided for exclusive use of the video presentation system 104. Router B is also communicatively coupled to video presentation client 414, which is communicatively coupled to the monitor 416.

The illustrative POS 402 tablet is an electronic device that may be operated cashier in a venue. The POS device 402 provides control over financial activity within the venue. The illustrative POS Application program runs on a tablet device and supports the following illustrative operations, namely, a cash-in operation (sales), a cash-out operation (redemption) and a reporting operation.

In the illustrative embodiment, the cashier logs into the POS application program by providing a cashier user name and password. During the set-up process, the cashier name is associated with a cashier role that is associated only with a particular venue. After a successful login, the POS client retrieves relevant system information from an illustrative distributor server 304, which presents the user interface 410.

The illustrative user interface 410 associated with POS client 402 presents colored icons, in which each icon represents one of the authorized mobile devices (such as authorized mobile devices 404 and 406) in the venue 408. Note that the illustrative authorized mobile devices 406 and 408 may also be referred to as “a registered gaming client.” By way of example, each icon 418 has a short identifier representing the local identification of the device, which is unique within that venue. For example, a grey icon may identify that the authorized mobile device has been registered with the mobile wagering sub-system; however, the authorized mobile device is not currently available for game play. Another illustrative icon may be a yellow icon, which represents that the authorized mobile device is present and available. A green icon may represent that the authorized mobile device has credit and is involved in a game session. A red icon may represent that a player input has been received that relates to a HELP button input command, a cash input command or a cash output command.

In operation, an illustrative cashier that is interactive with the user interface 410 may select an icon associated with a particular authorized mobile device. After selecting the appropriate authorized mobile device, the cashier may interact with another user interface that enables the cashier to add cash to the authorized mobile device, to enable a player cash-out from the authorized mobile device, to display a log of recent play and transactional activity, which may be retrieved from the illustrative centralized resource server, the distributor server or any combination thereof.

A variety of other user interfaces may also be presented in the point-of-sale device. For example, a user interface may be presented that allows the illustrative cashier to access reports and to log-out from the POS device. For example, a reports screen may be presented that summarizes the business activity of the current day, the previous day or a historical period. The reports may include data regarding cash-in sales (in dollars), awarded prizes (in US Dollars) and net revenue, which is the difference between the cash-in sales and the awarded prizes. The illustrative reports screen may be refreshed in real time or in pseudo real time.

By way of example and not of limitation, a player may interact with the centralized gaming system 100 by purchasing play credits, e.g. funds, at the POS device 402. For example, the illustrative player requests an amount of credit and pays the cashier at POS device 402. Subsequently, a POS session is established with the central database 314 (shown in FIG. 3) when the illustrative distributor server 304 receives a cash-in message from the POS client device 402. The illustrative cash-in message identifies the session amount, the identification of the authorized mobile device to which the POS session amount is linked and the identity of the POS device initiating the transaction. The distributor server 304 acknowledges that POS transaction and provides update information to the specific game client indicating the amount of available at credit. In addition, a player may elect to add credit to an existing balance by purchasing such credit from a cashier, who may use a POS ADD CASH function to record the transaction in the server database and update the available credit total.

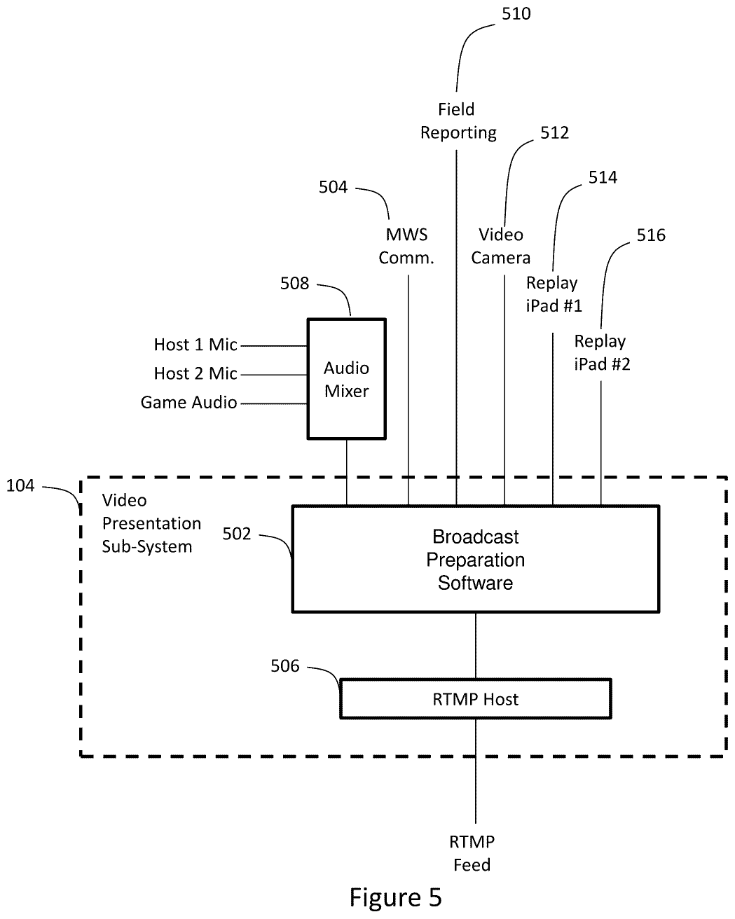

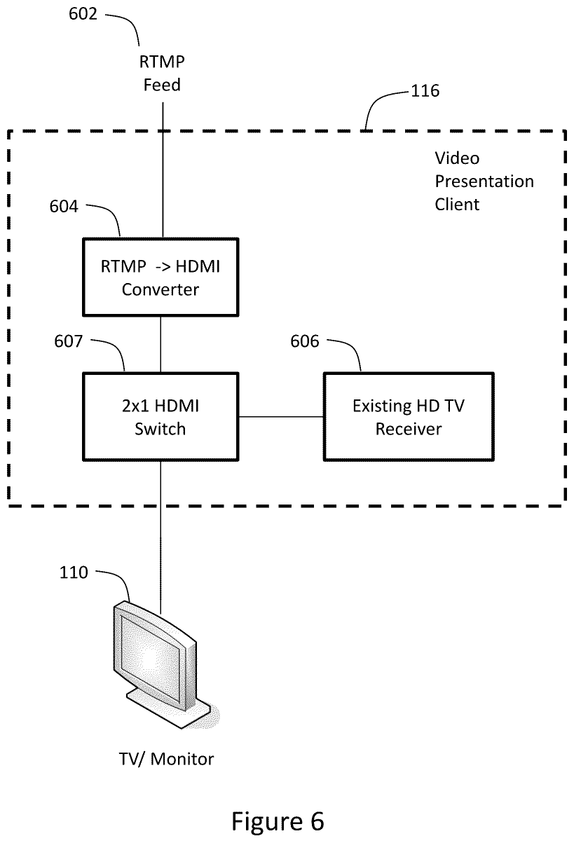

Referring to FIG. 5, there is shown an illustrative Video Presentation System (VPS). In the illustrative embodiment, the video presentation system (VPS) 104 delivers television content to venues communicatively coupled to the centralized gaming system 100 shown in FIG. 1. The illustrative VPS 104 is communicatively coupled to a VPS client 116, which is also shown in FIG. 6 below.

By way of example and not limitation, the VPS 104 may be associated with linked bingo tournament (LBT) games, electronic pull-tab tournaments, and other tournament games more generally. This content presented on illustrative monitors 110 (shown in FIG. 1) complements the game experience on the authorized mobile devices 112. Additionally, the content presented on monitors 110 is configured to involve other patrons at participating venues who are not participating in the games. This may create a social gaming environment that may appeal to a broad spectrum of players.

The illustrative VPS 104, shown in FIG. 5, includes a plurality of inputs that the system may incorporate into broadcast content. For example, communications with the MWS 102 may include a data feed generated by the MWS 102, which provides real time data on the status of an illustrative tournament. The illustrative data feed may include player names, player scores, remaining plays for player game sessions, time remaining in the tournament, prize values and other such tournament information.

A broadcast preparation software module 502 is configured to integrate a plurality of inputs into a broadcast data stream. In the illustrative embodiment, the integration is performed by a suite of commercial products such as Open Broadcaster™, Quicktime™, and proprietary software products. The tasks performed by the broadcast preparation software module 502 includes formatting an illustrative mobile wagering sub-system data feed 504. Note, the mobile wagering sub-system data feed 504 is generated by the mobile wagering sub-system 102. The mobile wagering sub-system data feed 504 includes information such as the tournament leader information, which can be converted into an easily readable display format.

For example, the mobile wagering sub-system data feed 504 may be transmitted over the Internet to a Real Time Messaging Protocol (RTMP) host 506, which may then transmit the data signal from the illustrative RTMP host 506 using an RTMP protocol over the Internet to the illustrative VPS client 116.

The broadcast preparation software module 502 may also be configured to interface with an illustrative audio mixer 508, which accepts a variety of audio feeds. The illustrative audio feeds received by the audio mixer 508 include host microphones and audio from selected live game play; a wide variety of such devices are commercially available. Additionally, the broadcast preparation software module 502 is configured to provide live field reporting 510 from game locations using a tool such as Facetime™. Live field reporting 510 may add excitement to the broadcast. Furthermore, the broadcast preparation software module 502 is configured to interface with various video signals that include studio video cameras 512 and live images captured from illustrative authorized mobile device and replayed as feed 514 and feed 516.

Referring to FIG. 6, there is shown a more detailed view of an illustrative video presentation sub-system (VPS) client 116. In the illustrative embodiment, the VPS client 116 is communicatively coupled to the video presentation sub-system 104 via an illustrative wide area network, e.g. Internet, and a local wireless connection, e.g. local Wi-Fi. The illustrative RTMP feed 602, which is generated by the RTMP host 506, is received by the VPS client 116. The VPS client is also operationally coupled to the illustrative stationary monitor 110.

The RTMP feed 602 is received at an illustrative gaming venue and the RTMP feed 602 is routed to the VPS client 116. By way of example and not of limitation, the RTMP feed 602 is communicated using a dedicated and secure Wi-Fi channel. In the illustrative embodiment, the RTMP feed 602 includes a streaming video data stream, which is converted to a video display signal. For example, the RTMP feed may be converted to an HDMI video signal with an RTMP/HDMI converter 604. For example, the RTMP/HDMI converter 604 may be implemented with special purpose firmware inside an embedded computing element, such as a Raspberry PI™. The resulting video signal generated by the RTMP/HDMI converter 604 is then sent directly to a compatible television or sent to the television using a commercial 2×1 switch 607, such as the Fosman 8024™, which may also be coupled to an existing HDTV data source such as receiver 606.

The illustrative converted HDMI video signal is then presented on the stationary monitor 110. This allows for a variety of installation models. Where there is a television dedicated to use with the VPS the output of the special purpose RTMP/HDMI converter 604 may be left permanently connected to the television or stationary monitor 110. If the television is used for different purposes at different times the data feed to the television can be switched on or off with the introduction of the 2×1 HDMI switch 607, allowing normal use of the television when the VPS data feed is not in use.

The centralized gaming system 100 described in FIG. 1 through FIG. 6 supports a variety of different types of games and game play, including game play for electronic pull-tabs having modifiable paytable animations. For the illustrative mobile wagering sub-system 102, a game session is initiated after a wager is received and the game session ends when game play is completed, when a prize is awarded, or according to any other predetermined game mechanic that reflects the game session has ended.

A variety of different game mechanics may be associated with each game session. For example, a tournament game awarding a limited number or prizes may present player rankings for prizes awarded to the ranked players. For another example, an electronic pull-tab tournament game may award limited or no prizes to players based on player rankings, since the electronic pull-tab tickets themselves may award the tournament players prizes.

The player rankings may then be presented on one or more of the authorized mobile devices 112. Additionally, the player rankings may result in the video presentation sub-system 104 generating a player rankings game session output that is presented on the stationary monitors 110.

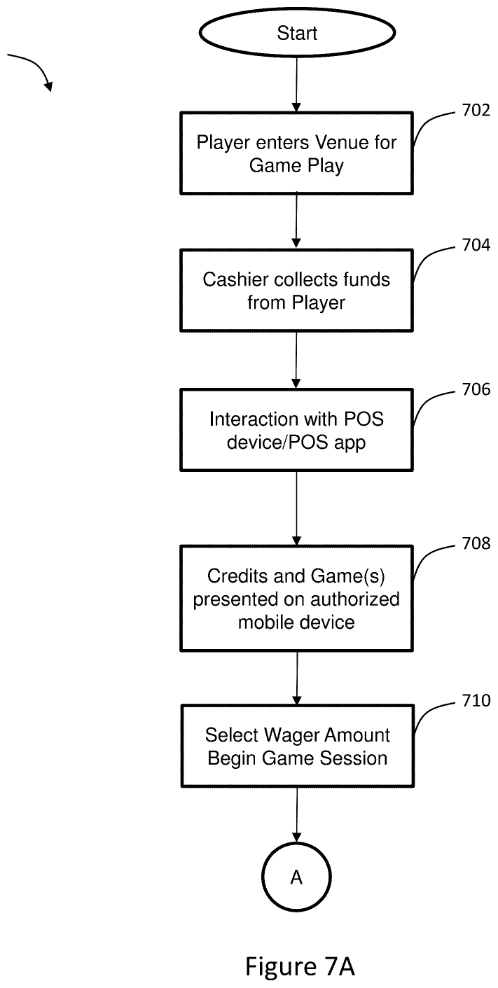

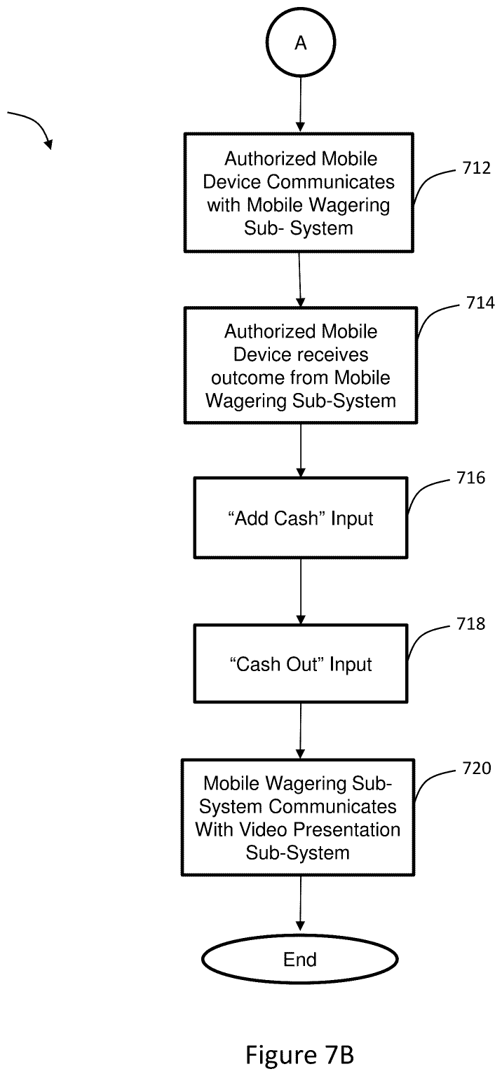

Referring to FIGS. 7A and 7B, there is shown an illustrative centralized gaming method that describes the various steps performed by a player interacting with the gaming system. The illustrative centralized gaming method 700 is at block 702 where an illustrative player enters one of the venues and indicates to the cashier or similar venue employee that the player wants to initiate game play with the centralized gaming system 100. The method then proceeds to block 704 where the illustrative cashier collects monetary funds such as cash, e-money, debit card, credit card and other such monetary funds as are appropriate depending on jurisdictional regulatory requirements.

At block 706, the illustrative cashier then proceeds to interface with a Point-Of-Sale (POS) application on a device such as POS device 114. In another embodiment, the player may interface with a kiosk version of the POS device 114 without the need to interact with a venue employee. In yet another embodiment, the POS application may be running on an authorized mobile device 112 and the player may interact directly with the POS application.

While interfacing with the POS device or POS application at block 706, the illustrative cashier identifies the authorized mobile device 112 associated with the player. The illustrative cashier then proceeds to enter the amount of credits to add to the authorized mobile devices. This amount of credits is stored in illustrative central database 314 (shown in FIG. 3).

At block 708, the total credits, which correspond to the collected funds, are presented on the authorized mobile device 112. The player may then interact with a game application running on the authorized mobile device. The player may also select from a variety of different game applications, which may be presented as a menu of games displayed on the authorized mobile device 112 screen. In operation, various game screens corresponding to the chosen game are presented to the player.

At block 710, the player can select a wager amount for a particular game session. In the illustrative embodiment, the wager amount includes the number of credits the player has selected to be wagered. Depending on jurisdictional requirements wager amounts can be expressed in dollars and cents (or other local currency) or in terms of credits, where each unit of credit has a monetary value. By way of example and not of limitation, the player may then initiate the game session by pressing a PLAY button, which is an illustrative game input received by the authorized mobile device 112.

At block 712, a game request is sent from the authorized mobile device 112 to the mobile wagering sub-system 102. The mobile wagering sub-system 102 processes the game request. In the illustrative embodiment, the mobile wagering subsystem 102 determines a prize result and a graphic representation (or representations) of the prize result. Additionally, the mobile wagering sub-system 102 logs the transaction, updates database game information, and updates an accounting module to reflect the amount spent and player winnings corresponding to the game session. Furthermore, the mobile wagering sub-system 102 sends a response message (or messages) to the authorized mobile device specifying the information to be displayed and the new value of the player account.

The method then proceeds to block 714 where the authorized mobile device 112 receives the outcome(s) from the mobile wagering sub-system 102. For example, the authorized mobile device 112 is configured to present animations and other results associated with the game session. The authorized mobile device 112 may also include an updated accounting of total credits and the prize amounts awarded. After the game session is completed, the player can return to the game menu at any time and select a different game to play.

At block 716, the authorized mobile device receives an “Add Cash” input. By way of example, the player decides to add funds to their play amount by providing the “Add Cash” input, which alerts the illustrative cashier that the player wants to add cash to their session total. The cashier then proceeds to interact with the POS device 114 or POS App (not shown). The illustrative cashier then proceeds to enter the amount of credits to add to the authorized mobile devices and the credits are stored in the illustrative central database 314.

At block 718, the authorized mobile device receives a “Cash Out” input. For example, when the player has finished the game session and wants to “Cash Out” the player presses a “Cash Out” button on the authorized mobile device 112. In the illustrative embodiment, after the authorized mobile device receives the “Cash Out” input, the illustrative cashier is notified that the player desires to “Cash Out.” Using the POS device 114 of the POS App (not shown), the illustrative cashier selects the “Cash Out” input and obtains the total credits remaining on the authorized mobile device after has completed one or more game session. The remaining account total information is received from the mobile wagering sub-system 102. The cashier pays the player the amount due and confirms the payment at the POS. The client device is then available for use by another player.

The method then proceeds to block 720 where mobile wagering sub-system 102 is configured to communicate with the video presentation sub-system 104. At block 720, the video presentation subsystem 104 receives game play information and integrates it with other data sources as described above. The video presentation subsystem 104 generates a video presentation that is broadcast via a private network to participating gaming venues. As described above a stationary monitor 110 is communicatively coupled to the video presentation sub-system 104 via the video presentation client 116. The stationary monitor client is configured to receive and present the game session output generated by the video presentation sub-system. In one illustrative embodiment, the video content is designed to provide enhanced content to the players and to increase the interaction between the players and the games. Additionally, the video content adds interest and excitement to the games. In addition to game-specific content, such as broadcasting a live tournament, the system can be used for a multitude of purposes, including, but not limited to, announcements and pictures on winners, informational videos about sponsoring charities, announcements of new games and upcoming events, advertising, etc.

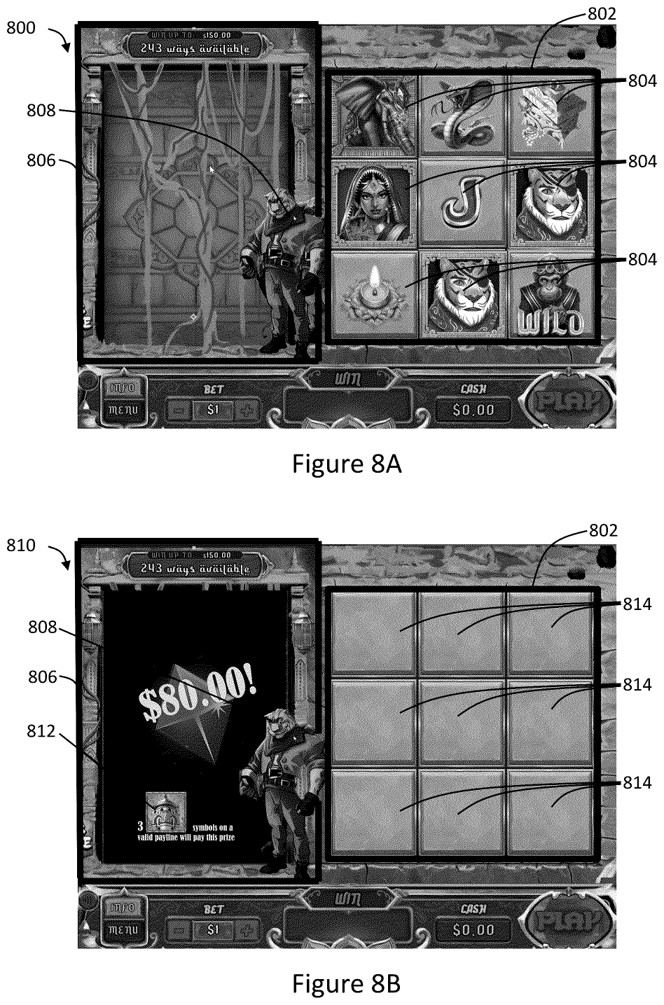

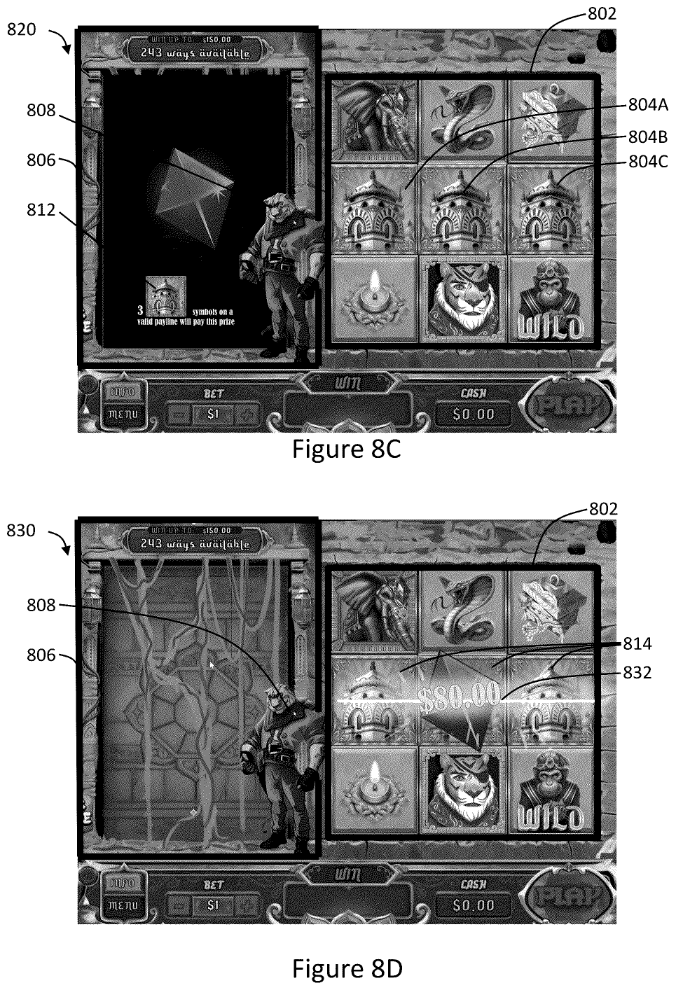

With reference now to FIGS. 8A-D, there are shown game screens 800, 810, 820, 830 depicting a first embodiment of a paytable modification animation for an electronic pull-tab ticket game. Paytable modification animations may more generally be termed entertaining animations where the player is instructed of a modification to the paytable for their ticket.

In FIG. 8A, the game screen 800 shows the layout of an illustrative Tiger Temple electronic pull-tab game having a win amount paytable modification animation. Each illustrative Tiger Temple game ticket includes a primary display area 802 where a grid of game symbols 804 are displayed, and a secondary display area 806 where any paytable modification animations are displayed. In the illustrative embodiment, the secondary display area 806 includes a tiger avatar 808 that animates to display paytable modifications. The illustrative game screen 800 captures a non-game session display prior to a player initiating a new game session where a random assortment of game symbols 804 that do not form any winning paylines are displayed in the primary display area 802 and no paytable modifications are presented in the second display area 806.

In the illustrative embodiment, the entertaining animations disclosed herein are elements of the primary game session. In some embodiments, the entertaining animations disclosed herein are elements of (or comprise entirely) a bonus game session.

While the illustrative embodiment presents a grid of game symbol display positions, the term “grid” is interchangeable with similar terms, such as “reel”, unless otherwise stated herein. Further, a grid may comprise a single row, a single column, multiple rows, and/or multiple columns, and is not limited to the illustrative 3×3 grid depicted in FIG. 8A and other figures herein. Further still, each row or column of a grid is not limited to three (3) game symbol display positions, and may include more or fewer game symbol display positions.

In FIG. 8B, the game screen 810 shows a game session display after a player has initiated gameplay and received a win amount paytable modification animation in the secondary display area 806. In the game screen 810, the tiger avatar 808 has performed a paytable modification animation to display to the player a modification to a base or standard paytable for the Tiger Temple game where three “Tower” symbols 812 pay $80.00 instead of a lesser base payout. In game screen 810, the game state has proceeded from initiation by player input to a pre-reveal win amount paytable modification animation before revealing the game symbols to the player. This game state and animation may be triggered by metadata contained in the pull-tab ticket. The metadata causes the gaming device to present the win amount paytable modification animation to the player, then reveal game symbols to the player where the modification to the paytable may yield a greater award to the player than the award listed in a standard or base paytable. In the illustrative embodiment, at least one element of metadata contained on each electronic pull-tab ticket is a paytable modification value that indicates to a gaming device reading the electronic pull-tab ticket a particular paytable modification animation to display on the gaming device to a player and a correspond payout for a particular symbol or combination of symbols. Since game screen 810 shows the gameplay display for the primary display area 802 prior to revealing the game symbols (not shown), each game symbol display position 814 is blank.

In some embodiments, the posted paytable for a player's ticket may include a range of payouts for one or more symbol combinations. In these embodiments, the paytable modification animation serves as a paytable definition animation where the player is informed of the particular value within a previously provided range of values that one or more symbol combination is worth on the player's particular ticket. In these embodiments, the paytable is defined only after the player initiates gameplay. For the example of game screen 810, the previously posted range of payouts for three “Tower” symbols 812 on a payline was $10.00-$100.00, but upon initiating gameplay the paytable modification animation defined for the player that three “Tower” symbols 812 on a payline pays $80.00.

In FIG. 8C, the game screen 820 shows the revealed game symbols for the player's game session, where a row or column of grid positions display three Tower game symbols 804A-C that match the win amount paytable modification 812 shown in display area 806.

In FIG. 8D, the game screen 830 shows the winning horizontal payline 822 of the three Tower game symbols 804A-C and the associated $80.00 award in the primary display area 802.

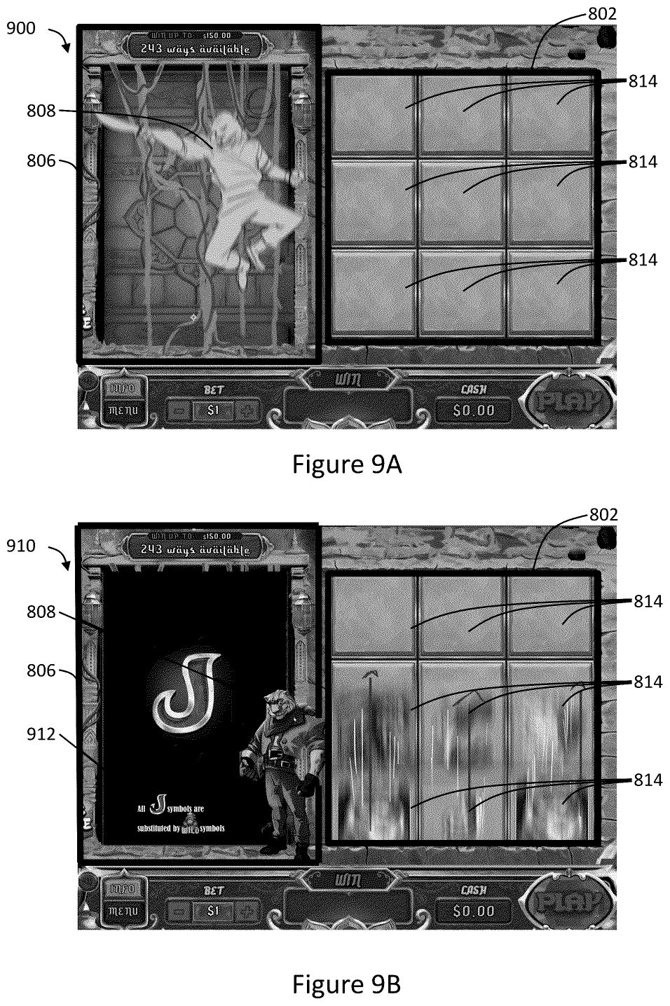

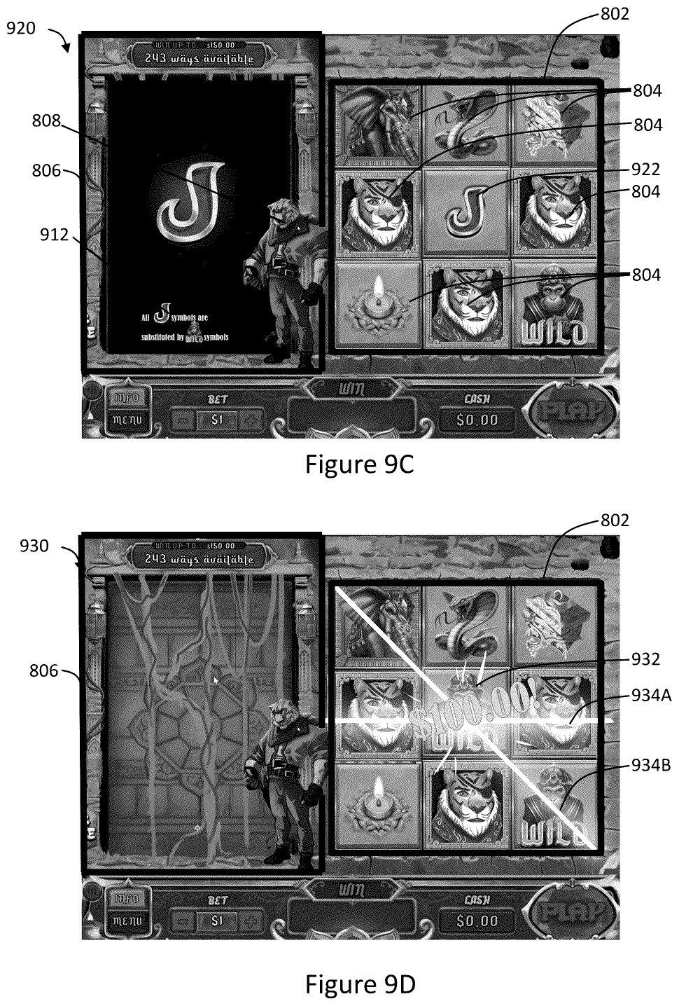

Referring now to FIGS. 9A-D, there are shown game screens 900, 910, 920, and 930 depicting a second embodiment of the paytable modification animation for an electronic pull-tab ticket game. In FIG. 9A, the game screen 900 shows the layout of the illustrative Tiger Temple electronic pull-tab game having a symbol substitution paytable modification animation. The illustrative embodiment displays the pre-reveal paytable modification within a game session, after initiation by a player input and before reveal of the game symbols. Since the game symbols have not yet been displayed, the symbol display positions 814 are left blank. In the illustrative embodiment, the secondary display area 806 includes a tiger avatar 808 in the midst of performing a symbol substitution paytable modification animation.

In FIG. 9B, the game screen 910 shows the result of the symbol substitution paytable animation being performed in game screen 900. Here, the secondary display area 806 now shows that the “J” or “Jack” game symbol 912 will be substituted by a “WILD” game symbol. The illustrative embodiment displays the pre-reveal paytable modification within a game session, after initiation by a player input and before reveal of the game symbols, during a game symbol reveal animation in the primary display area 802 where the game symbol display positions 814 do not yet show game symbols therein.

In game screen 910, the game state has proceeded from initiation by player input to completion of a pre-reveal symbol substitution paytable modification animation before revealing the game symbols to the player. This game state and associated animation may be triggered by meta data contained in the pull-tab ticket. The metadata causes the gaming device to present the symbol substitution paytable modification animation to the player, then reveal game symbols to the player where the modification to the paytable may yield a greater award to the player than the award corresponding to the initially revealed game symbols.

In FIG. 9C, the game screen 920 shows the reveal of an initial set of game symbols 804 that include one Jack game symbol 922 in the center grid position. The revealed game symbols 804 and 922 are initial game symbols because the Jack game symbol 922 has not yet been substituted for by a WILD symbol, as indicated by the Jack game symbol 912 shown in the secondary display area 806.

In FIG. 9D, the game screen 930 shows the revealed final game symbols 804 and 932, as well as the resulting winning paylines 934A and 934B. The winning paylines 934A and 934B result from the substitution of the Jack game symbol in the center display position of the game grid in the primary display area 802 with a WILD game symbol 932.

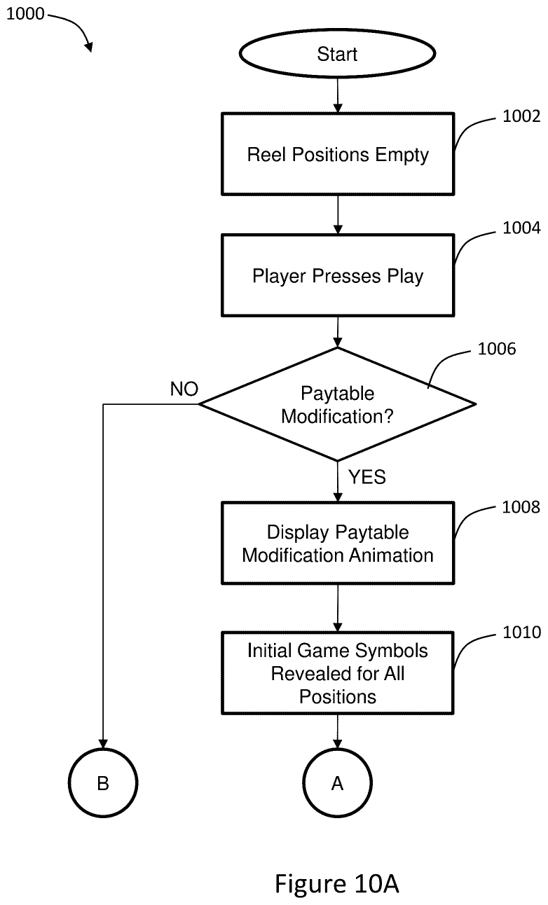

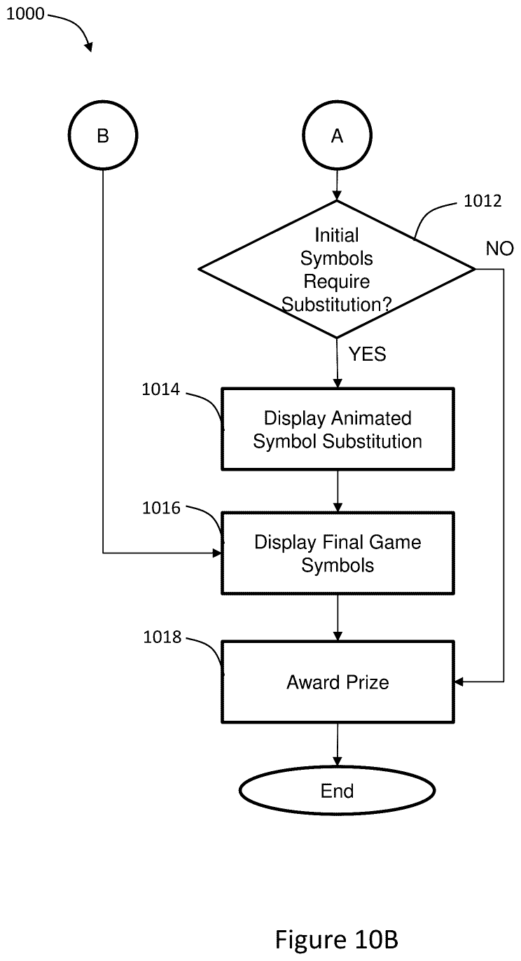

With reference now to FIGS. 10A and 10B, there is shown an illustrative flowchart for a method 1000 of providing animated paytable modifications for electronic pull-tab tickets. The method 1000 begins at step 1002 where all game symbol display positions are empty or blank. At step 1004, player input initiates a game session for an animated paytable modification electronic pull-tab ticket. Player input may be in the form of a click, button press, or touch screen selection. In illustrative embodiment, the player selects a “PLAY” button to enter their player input and initiate the game session.

Upon the player initiating their game session at step 1004 by pressing “PLAY”, the method proceeds to decision diamond 1006 where the gaming device reads an electronic pull-tab ticket received from the centralized gaming system and determines whether the received ticket includes a paytable modification. When the received ticket does not include a paytable modification, the method proceeds directly to step 1016 where the final game symbols are revealed on the gaming device and displayed to the player. When the received does include a paytable modification, the method proceeds to step 1008 where the gaming device display a paytable modification animation corresponding to the paytable modification indicated by the received ticket. The gaming device determines the presence or absence of a paytable modification by reading metadata from the received ticket indicating a paytable modification and the particular modification to be made, or the absence of a paytable modification. Where the gaming device reads the electronic pull-tab ticket and finds no paytable modification to be made, the metadata encoding any paytable modification may have a zero value or simply not be present on the ticket. Where the gaming device reads the electronic pull-tab ticket and finds the presence of a paytable modification to be made, the metadata encoding the paytable modification may have one or more non-zero values.

The paytable modification animation may be presented a background or secondary display area of the ticket outlay. In the illustrative embodiment, each paytable modification is displayed in the secondary display area of each ticket, and includes an animated action by a tiger avatar that results in an increased payout for a particular series of game symbols or a change in the quality of certain symbols. In the illustrative embodiment, this change in quality may be that certain types of symbols are treated as (or substituted for) wild symbols.

After displaying the paytable modification animation in step 1008, the method proceeds to step 1010 where initial game symbols are revealed for each game symbol display position. The revealed game symbols are termed initial game symbols for embodiments of the paytable modification indicating a change in quality of one or more game symbols. In operation, when the gaming device reads the ticket and determines the presence of a paytable modification at decision diamond 1006, the paytable modification may be coded into the ticket as metadata that additionally instructs the gaming device to display the initial game symbols of step 1010 first, then perform a symbol substitution animation of certain identified symbols and/or symbol positions, then display a final set of game symbols.

At decision diamond 1012, the gaming device determines whether any of the initial game symbols displayed is identified in the paytable modification for substitution. When the gaming device does not identify any initial game symbols for substitution, then the initial game symbols displayed are considered final game symbols and the method 1000 proceeds to step 1018. When the gaming device does identify one or more initial game symbols for substitution according to the paytable modification instruction, the method proceeds to step 1014.

At step 1014, the one or more initial game symbols identified by the gaming device for substitution are substituted with a WILD or other similar symbol provided for in the paytable modification. In the illustrative embodiment, this substitution is performed as an animation resulting in the presentation of the substituted symbol, i.e. WILD symbol.

At step 1016, after the one or more initial game symbols have been substituted in step 1014, the resulting game symbols presented to the player on the gaming device are termed “final” game symbols. The present game symbols are termed “final” game symbols because no further changes or alterations to the game symbols will be performed and because this set of game symbols the symbols which signal or determine the presence of a winning payline.

At step 1018, the gaming device presents the award associated with the electronic pull-tab ticket based on the displayed final game symbols to the player. In the illustrative embodiment, the gaming device reads metadata from the receive ticket indicating an award value associated with that ticket, i.e., a ticket value.

The pull-tab games presented herein include an auto-close option that may be selected by the operator, for any game played at a particular venue. The auto-close option automatically replaces a finite game pool with a new pool when all prizes exceeding a predetermined value for the deck have been exhausted and the game may no longer be desirable by players. When the auto-close option is turned “ON,” a deck may automatically close and be replaced by a new deck when prizes over a game specific value set in the portal are gone. For example, a game may have 3 large value prizes and when the last prize is awarded, the deck may close and a new deck may open. By way of example and not of limitation, the auto close option is identified in the client game information when it is active, so players may know that it is active. A notification may also be given to all active clients when a new deck is open. This feature is attractive to players because they are always assured that there are always some valuable prizes remaining in a deck they may be playing.

The GLW 120 and MWS 102 systems are communicatively coupled to the VPS 104, which is communicatively coupled to the VPS video display as shown in FIG. 1. The VPS display provides the opportunity to highlight GLW players and the GLW events. The VPS display may be used to highlight regional standings, announce regional winners, show live or video clips of regional events, show live or video clips of the Tournament of Champions, show Interviews with PGL players, and other such GLW information. This close interaction between the VPS 104, MWS 102 and GLW 120 creates a social atmosphere, a spirit of competition, a sense of accomplishment, and improve the success of the wagering enterprise.

The illustrative gaming systems and methods presented above may include a plurality of server applications that configured to provide high-availability and redundancy, processes all inputs, generates outputs, and maintains a central database for accounting, game play, system configuration data, and other such data types. By way of example and not of limitation, critical system data regarding clients may be maintained a repository associated with the illustrative gaming system. Historical games results and leader board information may be maintained. Printable versions of this information may be available on the portal.

The illustrative client devices described in the illustrative embodiments are communicatively coupled to a gaming system database, which stores client device data. Additionally, the illustrative gaming system database is configured to be secure. Furthermore, the illustrative gaming system database manages the data that is received from client devices in geographically dispersed gaming venues.

The illustrative centralized gaming system may be disposed in a central site as described herein. The illustrative centralized gaming system may process information received over the internet backbone from client devices such as mobile devices, management terminals and other such client devices.

The illustrative MWS sub-system manages the funding of game play and operation of wagering games and overall system management. All gaming messaging between servers and client devices is sent and received over a secure internet network that directs network traffic to the appropriate server elements. A Portal service receives messages from management terminals and provides functionality to authorized users to control the system and access real-time and historical data. All server applications are structured to be deployable in a virtual server environment, configured for high availability with fail-over capabilities on hardware components and database structures that keep a multiplicity of all data records.

By way of example and not of limitation, the games supported by the wagering system include electronic pull-tabs, electronic pull-tab tournaments, embedded feature electronic pull-tabs, linked bingo, high-speed linked bingo with entertainment, bingo tournaments, slot games, video poker, multi-player poker, blackjack, roulette, and other casino or entertainment games.

Many game types, including electronic pull-tabs and the entertainment aspect of linked bingo have bonus modes that award prizes based on a theme-specific animation. Often these features take more play time than a conventional game. While these features are entertaining, many players who have played the games for some period of time find the time spent in animation wasteful. Therefore, this system features a unique option at the beginning of any potentially long bonus animation. The player is presented with a screen announcing the bonus and then is presented with an option to proceed with the bonus animation or bypass the animation and go directly to the prize award at the end of the animation.

It is clear that the infrastructure of the MWS with the added capabilities of the VPS can support a wide variety of game types, in addition to the ones described herein. Those games include slot machine games, video lottery games, poker, blackjack, skill-based wagering games, among others.

It should be noted that in jurisdictions that allow gaming outside of physically licensed areas some of the above-mentioned security considerations may be relaxed or replaced by more appropriate mechanisms.

It is to be understood that the detailed description of illustrative embodiments are provided for illustrative purposes. Thus, the degree of software modularity for the transactional system and method presented above may evolve to benefit from the improved performance and lower cost of the future hardware components that meet the system and method requirements presented. The scope of the claims is not limited to these specific embodiments or examples. Therefore, various process limitations, elements, details, and uses may differ from those just described, or be expanded on or implemented using technologies not yet commercially viable, and yet still be within the inventive concepts of the present disclosure. The scope of the invention is determined by the following claims and their legal equivalents.

What is claimed is:

1. A pull-tab gaming system comprising:
a network component that generates an electronic pull-tab deck including a plurality of electronic pull-tab tickets, in which each of the plurality of electronic pull-tab tickets associated with a ticket value, a paytable modification value, a set of final game symbols, and a display area, wherein the set of final game symbols includes a plurality of final game symbols;
a plurality of game symbol display positions associated with the display area;
a gaming device communicatively coupled to the network component, wherein the gaming device includes a processor, a memory, and a display;
an electronic pull-tab ticket request generated by the gaming device that is communicated to the network component, which selects one electronic pull-tab ticket associated with a non-zero paytable modification value;
the gaming device receives the electronic pull-tab ticket associated with the non-zero paytable modification value from the network component and displays the display area corresponding to the electronic pull-tab ticket; and
an input received at the gaming device triggers the gaming device to display a paytable modification animation corresponding to the received electronic pull-tab ticket non-zero paytable modification value.

2. The pull-tab gaming system of claim 1 wherein each of the plurality of electronic pull-tab tickets is further associated with a set of initial game symbols.

3. The pull-tab gaming system of claim 2 wherein the paytable modification animation includes display of a set of initial game symbols corresponding to the received ticket and substitution of at least one initial game symbol with at least one final game symbol.

4. The system of claim 1 wherein the network component awards the ticket value to a player account.

5. The system of claim 1 wherein each of the plurality of electronic pull-tab tickets is further associated with a base paytable and a modified paytable, wherein the modified paytable is the base paytable when the paytable modification value is zero, and wherein the modified paytable is different from the base paytable when the paytable modification value is non-zero.

6. The system of claim 5 wherein each base paytable includes a range of payouts for one or more combination of final game symbols.

7. The system of claim 1 wherein each paytable modification animation corresponding to non-zero paytable modification values presents increased payouts for one or more combinations of final game symbols.

8. A pull-tab gaming method comprising:
generating an electronic pull-tab deck, by a network component, that includes a plurality of electronic pull-tab tickets, in which each of the plurality of electronic pull-tab tickets associated with a ticket value, a paytable modification value, a set of final game symbols, and a display area, wherein the set of final game symbols includes a plurality of final game symbols;
providing a plurality of game symbol display positions associated with the display area;
communicatively coupling a gaming device to the network component, wherein the gaming device includes a processor, a memory, and a display;
generating, by the gaming device, an electronic pull-tab ticket request;
communicating, by the gaming device, the electronic pull-tab ticket request to the network component;
selecting, by the network component, one electronic pull-tab ticket associated with a non-zero paytable modification value;
receiving, by the gaming device, the selected electronic pull-tab ticket associated with the non-zero paytable modification value from the network component and displaying the display area corresponding to the electronic pull-tab ticket; and
receiving, by the gaming device, an input that causes the gaming device to present a paytable modification animation corresponding to the received electronic pull-tab ticket non-zero paytable modification value.

9. The pull-tab gaming method of claim 8 wherein each of the plurality of electronic pull-tab tickets is further associated with a set of initial game symbols.

10. The pull-tab gaming method of claim 9 wherein the paytable modification animation includes display of a set of initial game symbols corresponding to the received ticket and substitution of at least one initial game symbol with at least one final game symbol.

11. The pull-tab gaming method of claim 8 further comprising awarding, by the network component, the ticket value to a player account.

12. The pull-tab gaming method of claim 8 wherein each of the plurality of electronic pull-tab tickets is further associated with a base paytable and a modified paytable, wherein the modified paytable is the base paytable when the paytable modification value is zero, and wherein the modified paytable is different from the base paytable when the paytable modification value is non-zero.

13. The pull-tab gaming method of claim 12 wherein each base paytable includes a range of payouts for one or more combination of final game symbols.

14. The pull-tab gaming method of claim 8 wherein each paytable modification animation corresponding to non-zero paytable modification values presents increased payouts for one or more combinations of final game symbols.

15. A pull-tab gaming system comprising:
a network component that generates an electronic pull-tab deck including a plurality of electronic pull-tab tickets, in which each of the plurality of electronic pull-tab tickets associated with a ticket value, a paytable modification value, a set of final game symbols, a primary display area, and a secondary display area, wherein the set of final game symbols includes a plurality of final game symbols;
a plurality of game symbol display positions associated with the primary display area;
a gaming device communicatively coupled to the network component, wherein the gaming device includes a processor, a memory, and a display;
an electronic pull-tab ticket request generated by the gaming device that is communicated to the network component, which selects one electronic pull-tab ticket associated with a non-zero paytable modification value;
the gaming device receives the electronic pull-tab ticket associated with the non-zero paytable modification value from the network component and displays both the primary display area and the secondary display area corresponding to the electronic pull-tab ticket; and
an input received at the gaming device triggers the gaming device to display in the secondary display area a paytable modification animation corresponding to the received electronic pull-tab ticket non-zero paytable modification value.

16. The pull-tab gaming system of claim 15 wherein each of the plurality of electronic pull-tab tickets is further associated with a set of initial game symbols.

17. The pull-tab gaming system of claim 16 wherein the paytable modification animation includes display of a set of initial game symbols and substitution of at least one initial game symbol with at least one final game symbol in the primary display area, wherein the set of initial game symbols correspond to the received ticket.

18. The system of claim 15 wherein the network component awards the ticket value to a player account.

19. The system of claim 15 wherein each of the plurality of electronic pull-tab tickets is further associated with a base paytable and a modified paytable, wherein the modified paytable is the base paytable when the paytable modification value is zero, and wherein the modified paytable is different from the base paytable when the paytable modification value is non-zero.

20. The system of claim 19 wherein each base paytable includes a range of payouts for one or more combination of final game symbols.
